(19) United States
(12) Patent Application Publication
(10) Pub. No.: US 2026/0233105 A1
(43) Pub. Date: Aug. 13, 2026

(54) PROVIDING NOISE TO TRAINED ARTIFICIAL INTELLIGENT AGENTS

(71) Applicant: SONY GROUP CORPORATION, Tokyo (JP)

(72) Inventors: Yunshu Du, Denver, CO (US); Songyang Han, New York, NY (US); Florian Fuchs, Zürich (CH); Kaushik Subramanian, Metzingen (DE); Peter Wurman, Acton, MA (US)

(21) Appl. No.: 19/049,685

(22) Filed: Feb. 10, 2025

(51) Int. Cl. A63F 13/67; A63F 13/56; A63F 13/803

(52) U.S. Cl. CPC A63F 13/67; A63F 13/56; A63F 13/803

(57) ABSTRACT

The behavior of a trained artificial intelligent agent can be varied by lying to the agent regarding certain features fed to the agent during deployment thereof. The variations in behavior can be achieved without re-training the agent, thus allowing a developer to cause the agent to make mistakes to edge the agent away from being perfect. Noise can be added to various inputs fed to the agent. For example, in a auto racing game, positional noise, velocity noise, tire slip data noise, wheel load noise, or the like, may be provided to the agent. Thus, by lying to the agent about certain data, through the inclusion of noise into the data fed to the agent, for example, the agent may behave away from its originally trained skill level, without requiring re-training of the agent.

### BACKGROUND OF THE INVENTION

### 1. Field of the Invention

Embodiments of the invention relate generally to systems and methods of using artificial intelligent agents. More particularly, embodiments of the invention relate to methods and systems for a for providing noise to a trained artificial intelligent agent to change its behavior in an environment, such as in a video game environment.

### 2. Description of Prior Art and Related Information

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

Artificial intelligent agents, especially those trained as competitors in video games, such as racing games, are often trained to be as close to perfect as possible, providing competition to even the most advanced game players. While agents may be trained at different skill levels, such trained agents are typically deployed without the further ability to alter their performance.

In view of the foregoing, there is a need for ways to alter an artificial intelligent agent's ability without retraining the agent.

### SUMMARY OF THE INVENTION

Embodiments of the present invention provide a method for modifying behavior of a trained agent comprising feeding data to the trained agent during deployment, wherein the fed data is changed from actual data regarding one or more features of the agent; and causing the agent to alter its behavior based on the fed data, wherein the behavior of the agent is modified without retraining the agent.

In some embodiments, which may be combined with the above embodiment, the agent is a racing game agent.

In some embodiments, which may be combined with any of the above embodiments, the fed data includes a position of the agent.

In some embodiments, which may be combined with any of the above embodiments, the fed data includes a velocity of the agent.

In some embodiments, which may be combined with any of the above embodiments, the fed data is fed to the agent with a delay from a real time of generation of the data.

In some embodiments, which may be combined with any of the above embodiments, the fed data includes changes in observations of an environment of an agent.

In some embodiments, which may be combined with any of the above embodiments, the environment includes course points along a race track in a racing game.

In some embodiments, which may be combined with any of the above embodiments, the fed data is changes with noise.

In some embodiments, which may be combined with any of the above embodiments, the noise is Ornstein-Uhlenbeck noise. In other embodiments, the noise can be selected from constant noise, contextual noise, time-dependent noise, Gaussian noise, or the like.

Embodiments of the present invention provide a method and a non-transitory computer readable storage medium tangibly embodying a computer readable program code having computer readable instructions that, when executed, causes a computer device to carry out a method of altering a behavior of an agent operating in a racing game environment, the method comprising feeding data to the trained agent, wherein the fed data is changed from actual data regarding one or more features of the agent performing in the racing game environment; and causing the agent to alter its behavior based on the fed data, wherein the behavior of the agent is modified without retraining the agent; and the fed data includes at least one of a position of the agent and a velocity of the agent.

These and other features, aspects and advantages of the present invention will become better understood with reference to the following drawings, description and claims.

### BRIEF DESCRIPTION OF THE DRAWINGS

Some embodiments of the present invention are illustrated as an example and are not limited by the figures of the accompanying drawings, in which like references may indicate similar elements.

FIG. 1 illustrates a schematic representation of an agent-operated race car in a racing video game, illustrating how lying to the agent about its environment can create changes in the actions of the agent;

FIG. 2 illustrates a graph of lap times for different levels of positional noise (that is, lying to the agent about its position) provided to the agent;

FIG. 3 illustrates a graph of agent speed for different directions of positional noise (that is, lying to the agent about its x, z or xz position) provided to the agent;

FIG. 4 illustrates a plan view of a race track course showing track with curved sections highlighted;

FIG. 5 illustrates a plan view of a race track course showing off course times where noise is added to a velocity feature of an agent-operated race car while the car is in a curve, illustrating how noise in velocities z and xz result in greater off course time than noise in velocity x; and

FIG. 6 illustrates the off course times of FIG. 5 in a bar graph format.

Unless otherwise indicated, the figures are not necessarily drawn to scale.

The invention and its various embodiments can now be better understood by turning to the following detailed description wherein illustrated embodiments are described. It is to be expressly understood that the illustrated embodiments are set forth as examples and not by way of limitations on the invention as ultimately defined in the claims.

### DETAILED DESCRIPTION OF THE PREFERRED EMBODIMENTS AND BEST MODE OF INVENTION

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

In the following description, for purposes of explanation, numerous specific details are set forth in order to provide a thorough understanding of the present invention. It will be evident, however, to one skilled in the art that the present invention may be practiced without these specific details.

The present disclosure is to be considered as an exemplification of the invention and is not intended to limit the invention to the specific embodiments illustrated by the figures or description below.

A “computer” or “computing device” may refer to one or more apparatus and/or one or more systems that are capable of accepting a structured input, processing the structured input according to prescribed rules, and producing results of the processing as output. Examples of a computer or computing device may include: a computer; a stationary and/or portable computer; a computer having a single processor, multiple processors, or multi-core processors, which may operate in parallel and/or not in parallel; a supercomputer; a mainframe; a super mini-computer; a mini-computer; a workstation; a micro-computer; a server; a client; an interactive television; a web appliance; a telecommunications device with internet access; a hybrid combination of a computer and an interactive television; a portable computer; a tablet personal computer (PC); a personal digital assistant (PDA); a portable telephone; application-specific hardware to emulate a computer and/or software, such as, for example, a digital signal processor (DSP), a field programmable gate array (FPGA), an application specific integrated circuit (ASIC), an application specific instruction-set processor (ASIP), a chip, chips, a system on a chip, or a chip set; a data acquisition device; an optical computer; a quantum computer; a biological computer; and generally, an apparatus that may accept data, process data according to one or more stored software programs, generate results, and typically include input, output, storage, arithmetic, logic, and control units.

“Software” or “application” may refer to prescribed rules to operate a computer. Examples of software or applications may include code segments in one or more computer-readable languages; graphical and/or textual instructions; applets; pre-compiled code; interpreted code; compiled code; and computer programs.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

Further, although process steps, method steps, algorithms or the like may be described in a sequential order, such processes, methods and algorithms may be configured to work in alternate orders. In other words, any sequence or order of steps that may be described does not necessarily indicate a requirement that the steps be performed in that order. The steps of processes described herein may be performed in any practical order. Further, some steps may be performed simultaneously.

It will be readily apparent that the various methods and algorithms described herein may be implemented by, e.g., appropriately programmed computers and computing devices. Typically, a processor (e.g., a microprocessor) will receive instructions from a memory or like device, and execute those instructions, thereby performing a process defined by those instructions. Further, programs that implement such methods and algorithms may be stored and transmitted using a variety of known media.

The term “computer-readable medium” as used herein refers to any medium that participates in providing data (e.g., instructions) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random access memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASHEEPROM, any other memory chip or cartridge, a carrier wave as described hereinafter, or any other medium from which a computer can read.

Various forms of computer readable media may be involved in carrying sequences of instructions to a processor. For example, sequences of instruction (i) may be delivered from RAM to a processor, (ii) may be carried over a wireless transmission medium, and/or (iii) may be formatted according to numerous formats, standards or protocols, such as Bluetooth, TDMA, CDMA, 3G, 4G, 5G or the like.

Embodiments of the present invention may include apparatuses for performing the operations disclosed herein. An apparatus may be specially constructed for the desired purposes, or it may comprise a device selectively activated or reconfigured by a program stored in the device.

Unless specifically stated otherwise, and as may be apparent from the following description and claims, it should be appreciated that throughout the specification descriptions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

In a similar manner, the term “processor” may refer to any device or portion of a device that processes electronic data from registers and/or memory to transform that electronic data into other electronic data that may be stored in registers and/or memory or may be communicated to an external device so as to cause physical changes or actuation of the external device.

As is well known to those skilled in the art, many careful considerations and compromises typically must be made when designing for the optimal configuration of a commercial implementation of any method or system, and in particular, the embodiments of the present invention. A commercial implementation in accordance with the spirit and teachings of the present invention may be configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

Broadly, embodiments of the present invention provide a varying behavior in a trained artificial intelligent agent by lying to the agent regarding certain features fed to the agent during deployment thereof. The variations in behavior can be achieved without re-training the agent, thus allowing a developer to cause the agent to make mistakes to edge the agent away from being perfect. Noise can be added to various inputs fed to the agent. For example, in a auto racing game, positional noise, velocity noise, tire slip data noise, wheel load noise, or the like, may be provided to the agent. Thus, by lying to the agent about certain data, through the inclusion of noise into the data fed to the agent, for example, the agent may behave away from its originally trained skill level, without requiring re-training of the agent.

As used herein, the term “noise” refers to an alteration to data fed to an artificial intelligent during deployment thereof. The noise may be Ornstein-Uhlenbeck (OU) noise, Gaussian noise, constant noise, time-dependent noise or the like.

Aspects of the present invention provide methods to determine if one can vary the behavior of an agent by lying about some of the input features. For example, if a system were to provide incorrect information about a car's speed or its position in a racing game, aspects of the present invention determine how the agent would respond, detailing how such changes may be used to cause the agent to make mistakes, determine if the mistakes (based on the level of noise added) are catastrophic, and provide the ability to alter the ability of the agent without requiring retraining of the policy for the agent. Depending on how the incorrect information is provided to the agent, it has been shown that such an approach generates desirable variations in the behavior of the agent. Incorrect information can be fed to a trained policy in order to generate a variety of behaviors. Importantly, this can be accomplished without any retraining. Depending on the environment of the agent, there are several dimensions that can be varied in this approach, and each could have a different effect. While the discussion below focuses on agents in a racing game environment, it should be understood that such added noise may also be useful in other gaming environments where agents are used with other game players.

Players control the agent with commands like go faster, overtake, save tires, and the like. Developers can influence game design and skill progression using a controllable agent, where the agent can be permitted to make “mistakes”. These mistakes can be introduced by adding (1) errors in vehicle or opponent position/speed; (2) delays in acquiring state information; and/or (3) delays in applying actions. Mistakes/noise can be added in several ways outside of position/velocity to the agent. It can be, for example, included on the position and velocity of the opponent cars in a race, the acceleration, and other information related to the agent's car or the opponent cars.

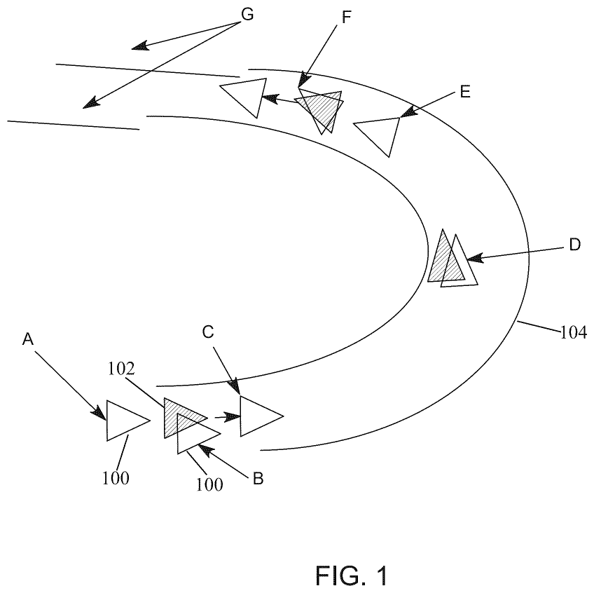

Referring to FIG. 1, at location A, an agent 100 may be “lied to” by providing delays in feeding the agent its position data. Such a delay may create, for example, late braking in approaching a curve in the race track 104. At location B, noise can be added about the agent's position, where agent 100 is the actual agent position, but the position of agent 102 is the information fed to the agent's policy. Such noise (also referred to as lying to the agent about its position) can result in late or early braking, missing a turn apex, or the like. At location C, if the agent uses a predicted position based on noise provided regarding the agent's velocity, the agent may brake early or late at a curve in the track 104. At location D, by adding noise about the agent's position, steering choices made by the agent may be altered. At location E, when the agent is coming out of a turn, a delay in providing the agent's position data (similar to that at location A) can result in a late return to throttle as the agent comes out of the curve. At location F, the agent may be lied to about its angle, tire slip or the like, which could result in various results, such as a late return to throttle, where the agent believes it is understeering. Finally, at location G, the system could lie to the agent about the course pointes (such as the left and right sides of the course, the spacing, curvature, or the like), which could force the agent to take a different lane or location on the track.

The above shows examples of how lying to the agent may change the behavior of the agent, without requiring changing the policy of the agent. It has been shown that, with certain agents, such as with GT Sophy in the Gran Turismo game, the agent may be lied to regarding certain features and the agent may make mistakes, however, such mistakes has been shown to not be catastrophic, thus permitting a developer to edge the agent away from being perfect without retraining the agent.

Both positional noise and velocity noise was explored to determine that such noise may be added to an agent in a racing game to provide variations in the agent's behavoir. While the below focuses on velocity and position noise, it should be understood that noise may be added to any feature data that is fed to an agent during deployment of the agent.

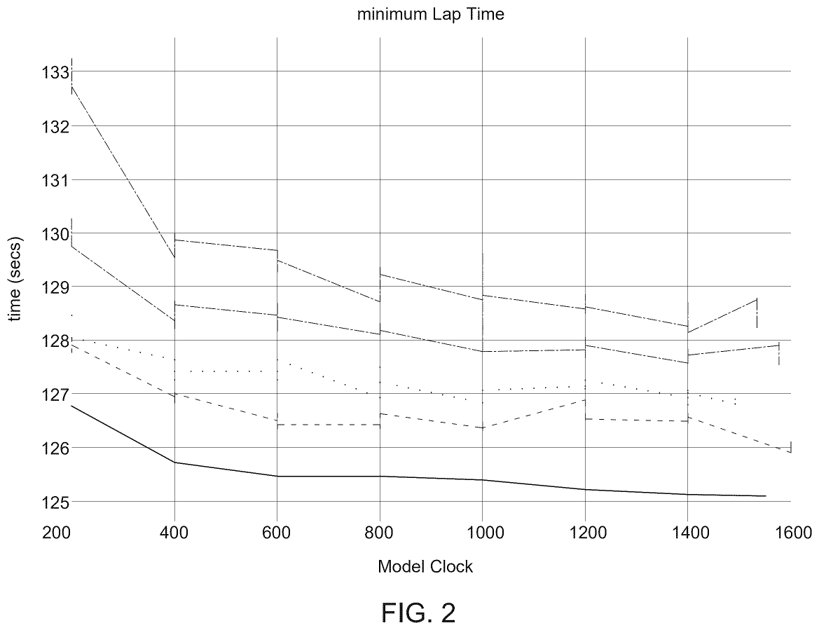

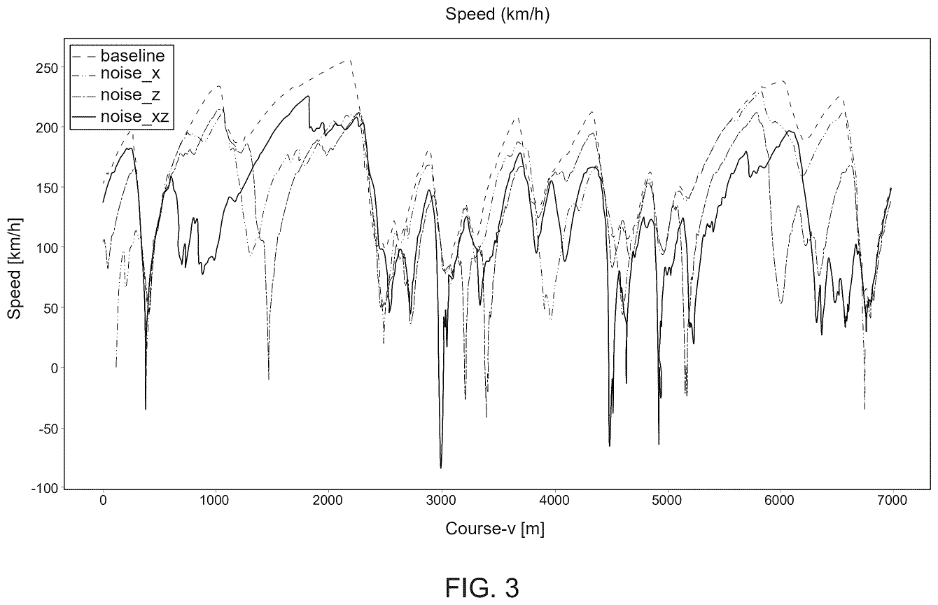

Referring to FIGS. 2 and 3, exemplary results are shown by providing positional noise to an agent in a racing game. The motivation for adding such noise, as discussed above, is to induce natural mistakes to the agent. It was found that, when independently sampling noise for each step, the noise averages out on few steps. Thus, temporarily correlated noise was added via an Ornstein-Uhlenbeck process. Such noise is referred to as OU noise. In FIG. 2, the upper line shows minimum lap time for added OU noise with sigma=5.0. the lower lines show minimum lap times for added OU noise with sigma=2.5, 1.0, 0.5 and 0.0, from top to bottom. Thus, it can be seen how adding more noise with respect to the agent's position, the lap time increases.

In FIG. 3, it can be seen how when noise is added to the agent's position, the agent's speed is reduced as it moves along the course. Positional noise is provided as noise_x, noise_z or noise_xz, wherenoise_x adds noise to the x dimension of the position feature, this changes the longitudinal position being fed to the agent; noise_z adds noise to the z dimension of the position feature, this changes the lateral position being fed to the agent; noise_xz changes both x and z dimension.

It also has been shown how similar noise added to the position of the agent can also affect the overall off course time of the agent. Further, by using OU noise, it has been shown that such noise results in much less off course time as compared to a fixed offset noise, which resulted in much more off course time. However, such noise can be selected so that the mistakes made by the agent, induced by the noise, do not amount to a catastrophic mistake and the agent typically continues in the race.

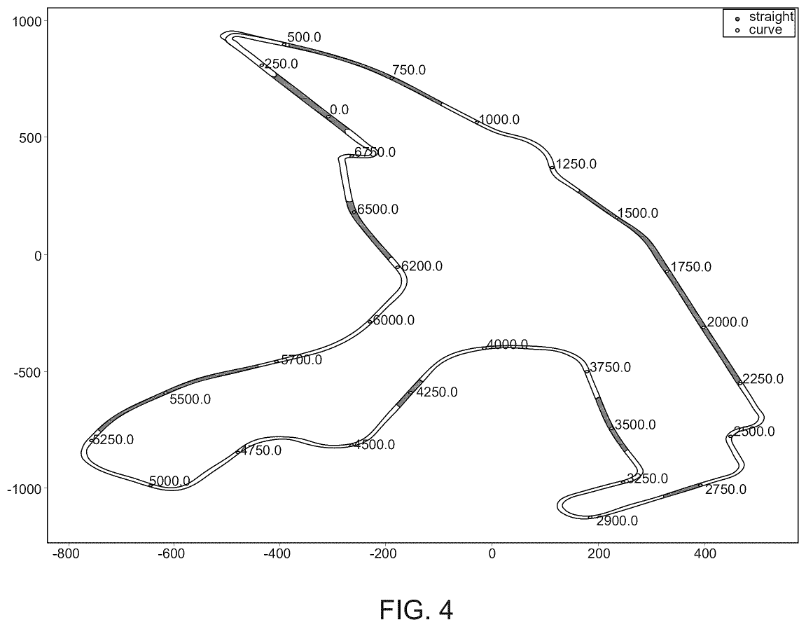

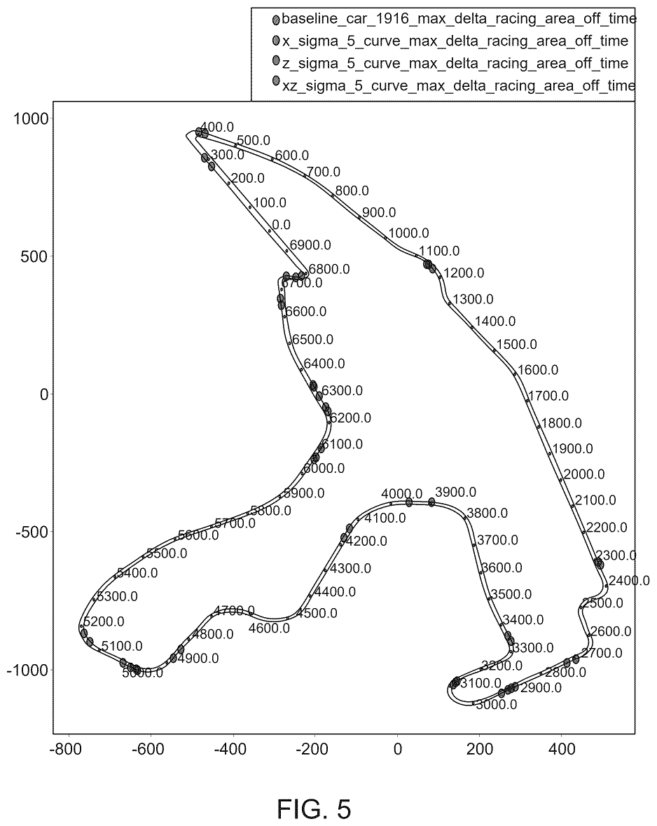

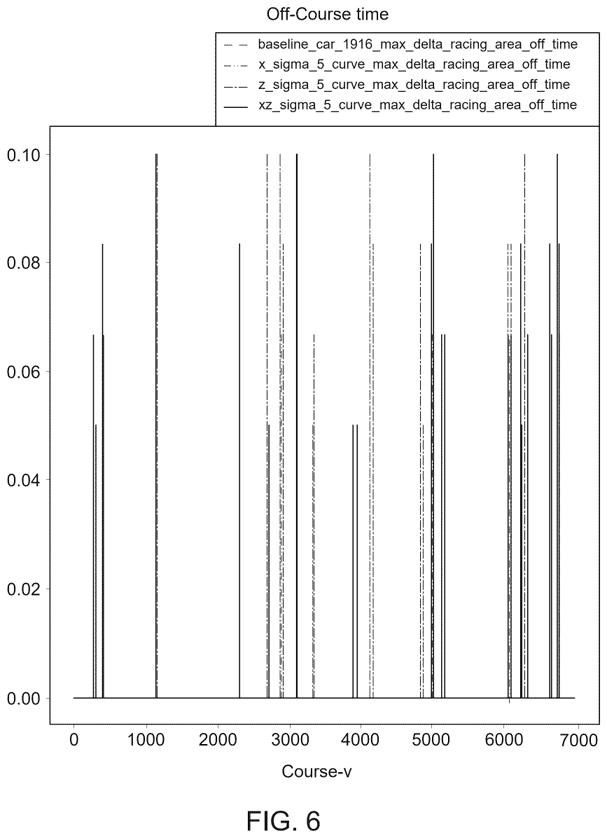

Referring to FIGS. 4, 5 and 6, it is shown how velocity noise (lying to the agent about its actual velocity) can affect the agent. In FIG. 4, highlighted curve sections are shown. In FIGS. 5 and 6, velocity noise is also provided only in the curves and the off course times are shown. It has been found that noises velocity z/xz results in a lot more off-course behaviors.

In summary, it has been shown that the existing policy for an agent in a racing game appears to be able to handle perturbations in the positions and velocity. OU noise with sigma=5 produces noises around ranges (−10, 10) and the policy is able to drive with that noise present. Tradeoffs in where, how and when the perturbations can be applied, such as by adding noise versus fixed offsets, in the intensity of the perturbation, whether the perturbations are applied all over the track, at curves only or the like, and in what feature(s) the perturbations are provided, such as speed, position or the like. It has been shown that changes along the z dimension results in more behavior variations than changing the x dimension, including behavior variations in driving lines, braking zones, off-course time or the like.

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

Claim elements and steps herein may have been numbered and/or lettered solely as an aid in readability and understanding. Any such numbering and lettering in itself is not intended to and should not be taken to indicate the ordering of elements and/or steps in the claims.

Many alterations and modifications may be made by those having ordinary skill in the art without departing from the spirit and scope of the invention. Therefore, it must be understood that the illustrated embodiments have been set forth only for the purposes of examples and that they should not be taken as limiting the invention as defined by the following claims. For example, notwithstanding the fact that the elements of a claim are set forth below in a certain combination, it must be expressly understood that the invention includes other combinations of fewer, more or different ones of the disclosed elements.

The words used in this specification to describe the invention and its various embodiments are to be understood not only in the sense of their commonly defined meanings, but to include by special definition in this specification the generic structure, material or acts of which they represent a single species.

The definitions of the words or elements of the following claims are, therefore, defined in this specification to not only include the combination of elements which are literally set forth. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptually equivalent, what can be obviously substituted and also what incorporates the essential idea of the invention.

What is claimed is:

1. A method for modifying behavior of a trained agent, comprising:
feeding data to the trained agent during deployment, wherein the fed data is changed from actual data regarding one or more features of the agent; and
causing the agent to alter its behavior based on the fed data,
wherein the behavior of the agent is modified without retraining the agent.

2. The method of claim 1, wherein the agent is a racing game agent.

3. The method of claim 1, wherein the fed data includes a position of the agent.

4. The method of claim 1, wherein the fed data includes a velocity of the agent.

5. The method of claim 1, wherein the fed data is fed to the agent with a delay from a real time of generation of the data.

6. The method of claim 1, wherein the fed data includes changes in observations of an environment of an agent.

7. The method of claim 6, wherein the environment includes course points along a race track in a racing game.

8. The method of claim 1, wherein the fed data is changes with noise.

9. The method of claim 8, wherein the noise is Ornstein-Uhlenbeck noise.

10. A method for altering a behavior of an agent operating in a racing game environment, comprising:
feeding data to the trained agent, wherein the fed data is changed from actual data regarding one or more features of the agent performing in the racing game environment; and
causing the agent to alter its behavior based on the fed data, wherein:
the behavior of the agent is modified without retraining the agent; and
the fed data includes at least one of a position of the agent and a velocity of the agent.

11. The method of claim 10, wherein the fed data is fed to the agent with a delay from a real time of generation of the data.

12. The method of claim 10, wherein the fed data includes changes in observations of an environment of an agent, wherein the changes in observations of the environment include changes from actual course points along a race track in a racing game.

13. The method of claim 10, wherein the fed data is changed with noise.

14. The method of claim 13, wherein the noise is Ornstein-Uhlenbeck noise.

15. A non-transitory computer readable storage medium tangibly embodying a computer readable program code having computer readable instructions that, when executed, causes a computer device to carry out a method for altering a behavior of an agent operating in a racing game environment, the method comprising:
feeding data to the trained agent, wherein the fed data is changed from actual data regarding one or more features of the agent performing in the racing game environment; and
causing the agent to alter its behavior based on the fed data, wherein:
the behavior of the agent is modified without retraining the agent; and
the fed data includes at least one of a position of the agent and a velocity of the agent.

16. The non-transitory computer readable storage medium of claim 15, wherein the fed data is fed to the agent with a delay from a real time of generation of the data.

17. The non-transitory computer readable storage medium of claim 15, wherein the fed data includes changes in observations of an environment of an agent, wherein the changes in observations of the environment include changes from actual course points along a race track in a racing game.

18. The non-transitory computer readable storage medium of claim 15, wherein the fed data is changed with noise.

19. The non-transitory computer readable storage medium of claim 18, wherein the noise is Ornstein-Uhlenbeck noise.
